(19) United States
(12) Patent Application Publication
(10) Pub. No.: US 2025/0095174 A1
(43) Pub. Date: Mar. 20, 2025

(54) Learning Device, Learning Method And Test Device, Test Method Using The Same

(71) Applicants: Hyundai Motor Company, Seoul (KR); Kia Corporation, Seoul (KR)

(72) Inventors: Jin Ho Park, Seoul (KR); Jin Sol Kim, Hwaseong-si (KR); Jang Yoon Kim, Seoul (KR)

(21) Appl. No.: 18/658,739

(22) Filed: May 8, 2024

(30) Foreign Application Priority Data
Sep. 20, 2023 (KR) 10-2023-0125735

(51) Int. Cl. G06T 7/50; G06T 7/246

(52) U.S. Cl. CPC G06T 7/50; G06T 7/248; G06T 2207/20081; G06T 2207/20084

(57) ABSTRACT

A learning device, a learning method thereof, a test device using the same, and a test method using the same are provided. The learning device may obtain a target image and a source image, generate an estimated depth map based on the target image via a first network, generate pose change information corresponding to a pose change between the target image and the source image, generate a composite image corresponding to the target image, determine a first loss based on the composite image and the target image, and determine a second loss, and back-propagate the first loss and the second loss and update a parameter of the first network and a parameter of the second network.

### CROSS-REFERENCE TO RELATED APPLICATION

This application claims the benefit of priority to Korean Patent Application No. 10-2023-0125735, filed in the Korean Intellectual Property Office on Sep. 20, 2023, the entire contents of which are incorporated herein by reference.

### TECHNICAL FIELD

The present disclosure relates to a learning device, a learning method thereof, a test device using the same, and a test method using the same, and more particularly relates to a learning device based on self-supervised learning, a learning method thereof, a test device using the same, and a test method using the same.

### BACKGROUND

Recently, with the development of deep neural network-based computer vision technology in an autonomous driving technology, various artificial intelligence models, such as object detection, semantic segmentation, depth map estimation, and lane detection, have been studied.

For example, the depth map estimation is variously used to recognize a surrounding environment and a space for surrounding objects, a free space, and the like using a camera in an autonomous driving condition. In general, there is a need for a large amount of data for training (e.g., a depth map for training) to which labels are assigned to train a network for generating a depth map.

However, the process of assigning a label to each of a large amount of images and inspecting it should be essentially performed to construct the data for training. A huge amount of time and resource are consumed from the stage for ensuring data for training for training a depth map generation network.

### SUMMARY

The present disclosure has been made to solve the above-mentioned problems occurring in some implementations while advantages achieved by those implementations are maintained intact.

An aspect of the present disclosure provides a learning device based on self-supervised learning, a learning method thereof, a test device using the same, and a test method using the same.

Another aspect of the present disclosure provides a learning device for reducing time and cost consumed to ensure data for training for training a depth map generation network, a learning method thereof, a test device using the same, and a test method using the same.

Another aspect of the present disclosure provides a learning device for allowing a depth map generation network to accurately estimate depth information based on an image sequence, a learning method thereof, a test device using the same, and a test method using the same.

Another aspect of the present disclosure provides a learning device for accurately estimating depth information for a dynamic object or an occluded object in an image, a learning method thereof, a test device using the same, and a test method using the same.

The technical problems to be solved by the present disclosure are not limited to the aforementioned problems, and any other technical problems not mentioned herein will be clearly understood from the following description by those skilled in the art to which the present disclosure pertains.

According to one or more example embodiments, a learning device may include: one or more processors and memory. The memory may store instructions that, when executed by the one or more processors, may configure the learning device to: obtain a target image and a source image; generate, via a first network, an estimated depth map based on the target image; generate, via a second network, pose change information corresponding to a pose change between the target image and the source image; generate a composite image corresponding to the target image by using the estimated depth map, the pose change information, and the source image; determine, based on the composite image and the target image, a first loss; determine, based on a pseudo depth map corresponding to the target image and the estimated depth map, a second loss; and back-propagate the first loss and the second loss, and update a parameter of the first network and a parameter of the second network.

The instructions, when executed by the one or more processors, may configure the learning device to determine the second loss by: determining, via the loss calculation device, the second loss further based on at least one of luminance information, contrast information, or structure information, of each of the pseudo depth map and the estimated depth map.

A first weight corresponding to the luminance information may be smaller than a second weight corresponding to the contrast information and smaller than a third weight corresponding to the structure information.

The target image may be generated by an image sensor at a first time. The source image may be generated by the image sensor at a second time within a threshold range around the first time.

The second network may include a pose change information generation network. The instructions, when executed by the one or more processors, may configure the learning device to generate the pose change information by generating, via the second network, the pose change information based on a first pose at the first time and a second pose at the second time.

The instructions, when executed by the one or more processors, may configure the learning device to: obtain, based on the estimated depth map, first three-dimensional (3D) point cloud information at the first time; convert, based on the pose change information, the first 3D point cloud information at the first time into second 3D point cloud information at the second time; convert, based on an image sensor parameter corresponding to the image sensor, the second 3D point cloud information into two-dimensional (2D) image coordinates; and generate the composite image by generating the composite image based on a pixel value of the source image corresponding to the 2D image coordinates.

The first network may include an estimated depth map generation network. The instructions, when executed by the one or more processors, may further configure the learning device to: generate, via a pseudo depth map generation network, the pseudo depth map based on the target image.

The pseudo depth map generation network may include a parameter in a frozen state.

According to one or more example embodiments, a system may include a test device and a learning device. The test device may include: an acquisition device configured to obtain a target image for testing; and a first network configured to generate, based on the target image, an estimated depth map for testing. The learning device may be configured to: obtain the target image and a source image; generate, via a second network, pose change information corresponding to a pose change between the target image and the source image; generate a composite image corresponding to the target image by using the estimated depth map, the pose change information, and the source image; determine, based on the composite image and the target image, a first loss; determine, based on a pseudo depth map corresponding to the target image and the estimated depth map, a second loss; and back-propagate the first loss and the second loss and update a parameter of the first network and a parameter of the second network. The test device may be configured to perform testing based on the updated parameters.

The test device may be configured to determine the second loss by: determining the second loss further based on at least one of luminance information, contrast information, or structure information, of each of the pseudo depth map and the estimated depth map.

A first weight corresponding to the luminance information may be smaller than a second weight corresponding to the contrast information and smaller than a third weight corresponding to the structure information.

The target image may be generated by an image sensor at a first time. The source image may be generated by the image sensor at a second time within a threshold range around the first time.

The second network may include a pose change information generation network. The test device may be configured to generate the pose change information by generating, via the pose change information generation network, the pose change information based on a first pose at the first time and a second pose at the second time.

According to one or more example embodiments, a learning method may include: obtaining, by one or more processors, a target image and a source image; generating, by the one or more processors, an estimated depth map based on the target image; generating, by the one or more processors, pose change information corresponding to a pose change between the target image and the source image; generating, by the one or more processors, a composite image corresponding to the target image by using the estimated depth map, the pose change information, and the source image; determining, by the one or more processors and based on the composite image and the target image, a first loss; determining, by the one or more processors and based on a pseudo depth map corresponding to the target image and the estimated depth map, a second loss; and back-propagating, by the one or more processors, the first loss and the second loss and updating a parameter of a first network for generating the estimated depth map and a parameter of a second network for generating the pose change information.

Determining the second loss may include: determining the second loss further based on at least one of luminance information, contrast information, or structure information, of each of the pseudo depth map and the estimated depth map.

A first weight corresponding to the luminance information may be smaller than a second weight corresponding to the contrast information and smaller than a third weight corresponding to the structure information.

The target image may be generated by an image sensor at a first time. The source image may be generated by the image sensor at a second time within a threshold range around the first time.

Generating the pose change information may include: generating the pose change information based on a first pose at the first time and a second pose at the second time.

Generating the composite image may include: obtaining first three-dimensional (3D) point cloud information at the first time; converting, based on the pose change information, the first 3D point cloud information at the first time into second 3D point cloud information at the second time; converting, based on an image sensor parameter corresponding to the image sensor, the second 3D point cloud information into two-dimensional (2D) image coordinates; and generating the composite image based on a pixel value of the source image corresponding to the 2D image coordinates.

The learning method may further include: generating, by a pre-trained pseudo depth map generation network, the pseudo depth map based on the target image before determining the second loss.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a learning device according to an embodiment disclosed in the present disclosure;

FIGS. 2, 3, 4A, and 4B are drawings for describing an operation of a learning device according to an embodiment disclosed in the present disclosure;

FIG. 5 is a flowchart for describing a learning method according to an embodiment disclosed in the present disclosure;

FIG. 6 is a block diagram illustrating a configuration of a test device according to an embodiment disclosed in the present disclosure;

FIG. 7 is a drawing for describing an operation of a test device according to an embodiment disclosed in the present disclosure; and

FIG. 8 is a flowchart for describing a test method according to an embodiment disclosed in the present disclosure.

With regard to description of drawings, the same or similar denotations may be used for the same or similar components.

### DETAILED DESCRIPTION

Hereinafter, some embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

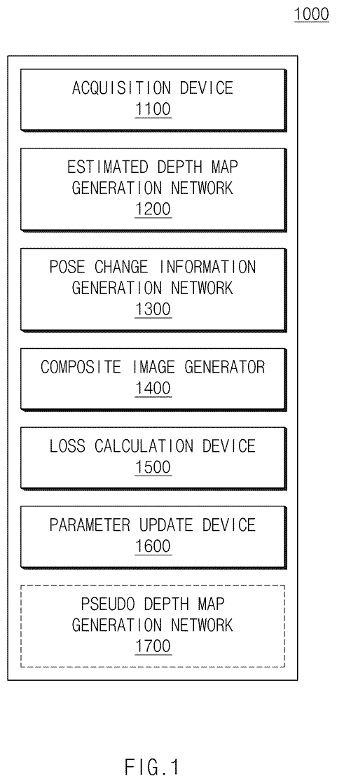

Hereinafter, embodiments of the present disclosure will be described in detail with reference to FIGS. 1 to 8.

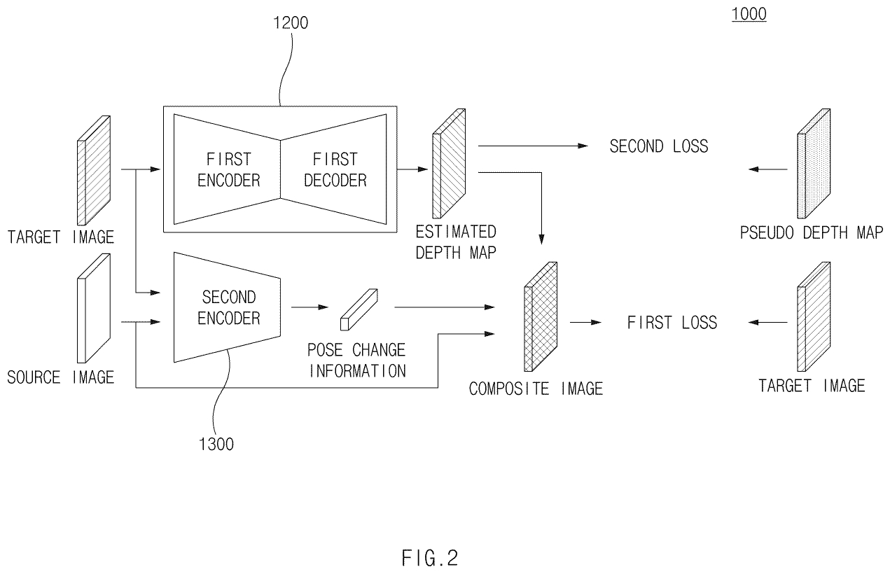

FIG. 1 is a block diagram illustrating a configuration of a learning device 1000 according to an embodiment disclosed in the present disclosure. FIGS. 2 to 4B are drawings for describing an operation of a learning device according to an embodiment disclosed in the present disclosure.

Referring to FIG. 1, the learning device 1000 may include an acquisition device 1100, an estimated depth map generation network 1200, a pose change information generation network 1300, a composite image generator 1400, a loss calculation device 1500, and a parameter update device 1600.

Furthermore, the learning device 1000 may additionally include a pseudo depth map generation network 1700. However, although described below, the pseudo depth map generation network 1700 is not an essential component of the learning device 1000 according to an embodiment disclosed in the present disclosure.

The learning device 1000 may include a memory for storing a program instruction, and a processor configured to execute the program instruction. The above-mentioned acquisition device 1100, the estimated depth map generation network 1200, the pose change information generation network 1300, the composite image generator 1400, the loss calculation device 1500, the parameter update device 1600, and the pseudo depth map generation network 1700 may perform a related function through the processor included in the learning device 1000.

Hereinafter, a description will be given in detail of an operation of the learning device 1000 according to an embodiment disclosed in the present disclosure with reference to FIG. 2.

First of all, the acquisition device 1100 may obtain a target image and at least one source image. Acquisition device may be a computing device.

For example, the target image may be generated by a specific image sensor at a specific time point, and the source image may be generated by the specific image sensor at a surrounding time point corresponding to the specific time point. At this time, the surrounding time point may be at least one time point among the remaining time points except for the specific time point, among time points in a threshold time interval with respect to the specific time point.

For example, the target image and the source image may be an image sequence obtained in the time interval including the specific time point.

Furthermore, the estimated depth map generation network 1200 may generate an estimated depth map based on the target image.

For example, the estimated depth map generation network 1200 may be a network of a U-net structure including an encoder and a decoder. At this time, the encoder may be a ResNet model, and the decoder may be a model for performing an operation of converting a sigmoid output into a depth map.

Furthermore, the pose change information generation network 1300 may generate pose change information corresponding to a pose change between the target image and the source image.

For example, the pose change information generation network 1300 may generate pose change information based on a first pose at the specific time point of the specific image sensor and a second pose at the surrounding time point.

For example, the pose change information may be information indicating a relationship between a camera pose at the specific time point and a camera pose at the surrounding time point, which may be information corresponding to rotation and translation matrices.

Furthermore, the composite image generator 1400 may generate a composite image corresponding to the target image using the estimated depth map, the pose change information, and the source image.

For example, the composite image generator 1400 may obtain three-dimensional (3D) point cloud information at the specific time point based on the estimated depth map.

The composite image generator 1400 may convert the 3D point cloud information at the specific time point into 3D point cloud information at the surrounding time point based on the pose change information.

The composite image generator 1400 may convert the 3D point cloud information at the surrounding time point into two-dimensional (2D) image coordinates based on an image sensor parameter (e.g., an intrinsic parameter) corresponding to the specific image sensor.

The composite image generator 1400 may generate a composite image based on a pixel value of the source image corresponding to the 2D image coordinates.

For example, the composite image generator 1400 may convert the 3D point cloud information at the specific time point (e.g., a first time) corresponding to (10, 20) of the estimated depth map into 3D point cloud information at the surrounding time point based on the pose change information. The composite image generator 1400 may convert the 3D point cloud information at the surrounding time point corresponding to (10, 20) of the estimated depth map into 2D image coordinates (e.g., (15,18)) based on the image sensor parameter.

The composite image generator 1400 may assign a pixel value (e.g., 218) of the source image corresponding to the 2D image coordinates (15, 18) at the surrounding time point (e.g., a second time within a threshold range around the first time) to (10, 20) to generate a composite image.

When the pose change information is accurate, a pixel value (e.g., 250) of the source image, which is assigned to each pixel (e.g., (30, 50)) of the composite image, may be the same as or similar to a pixel value (e.g., 251) assigned to the pixel (e.g., (30, 50)) of the same position as the target image. When the pose change information is inaccurate, the pixel value (e.g., 250) of the source image, which is assigned to each pixel (e.g., (30, 50)) of the composite image, may have a large difference with a pixel value (e.g., 89) assigned to the pixel (e.g., (30, 50)) of the same position as the target image.

Furthermore, the loss calculation device 1500 may calculate a first loss based on the composite image and the target image and may calculate a second loss based on a pseudo depth map corresponding to the target image and the estimated depth map. A loss calculation device may be a computing device.

For reference, the estimated depth map generation network 1200 trained using only the first loss based on the composite image and the target image may generate an estimated depth map in which an object boundary is represented in a blurred manner for a dynamic object or an object, a portion of which is occluded.

Thus, to generate an estimated depth map in which an object boundary is clearly represented for the dynamic object or the object, the portion of which is occluded, as well as the first loss, the second loss based on an error between the pseudo depth map and the estimated depth map may be additionally used to train the estimated depth map generation network 1200.

At this time, the pseudo depth map may be obtained from the pseudo depth map generation network 1700. The learning device 1000 according to an embodiment disclosed in the present disclosure may obtain, but is not limited to, the pseudo depth map generated by the pseudo depth map generation network 1700. For example, the learning device 1000 may additionally include the pseudo depth map generation network 1700.

At this time, the pseudo depth map generation network 1700 may generate a pseudo depth map based on the target image. For reference, the pseudo depth map generation network 1700 may have a parameter in a frozen state.

For example, the pseudo depth map generation network 1700 may be a network pre-trained using a large amount of training datasets, which may include more (e.g., a higher quantity of) layers than the estimated depth map generation network 1200 according to an embodiment disclosed in the present disclosure and may be a high-capacity network including more (e.g., a higher quantity of) parameters than the estimated depth map generation network 1200 according to an embodiment disclosed in the present disclosure.

For reference, it is difficult for the high-capacity network to be loaded into a device (e.g., a vehicle) with limited resources in that the pseudo depth map generation network 1700 is the high-capacity network. Meanwhile, the depth map output from the pseudo depth map generation network 1700 may be higher in accuracy than the depth map output from the estimated depth map generation network 1200 according to an embodiment disclosed in the present disclosure.

Thus, only an advantage (i.e., high accuracy) of such a high-capacity network may be used to increase the accuracy of the actually loaded network (i.e., the estimated depth map generation network 1200) and reduce costs necessary to construct training data. In other words, the output of the pseudo depth map generation network 1700 may be used as correct answer data for training the estimated depth map generation network 1200.

For reference, the accuracy of the pseudo depth map of the pseudo depth map generation network 1700 may be relatively greater than the accuracy of the estimated depth map of the estimated depth map generation network 1200, but may be lower than the accuracy of a ground truth (GT) depth map generated through a process in which an inspector manually and separately perform inspection.

Thus, when the estimated depth map generation network 1200 is trained by simply using only a loss generated based on a regression-based loss function corresponding to the pseudo depth map and the estimated depth map, the accuracy of the estimated depth map generation network 1200 may be small.

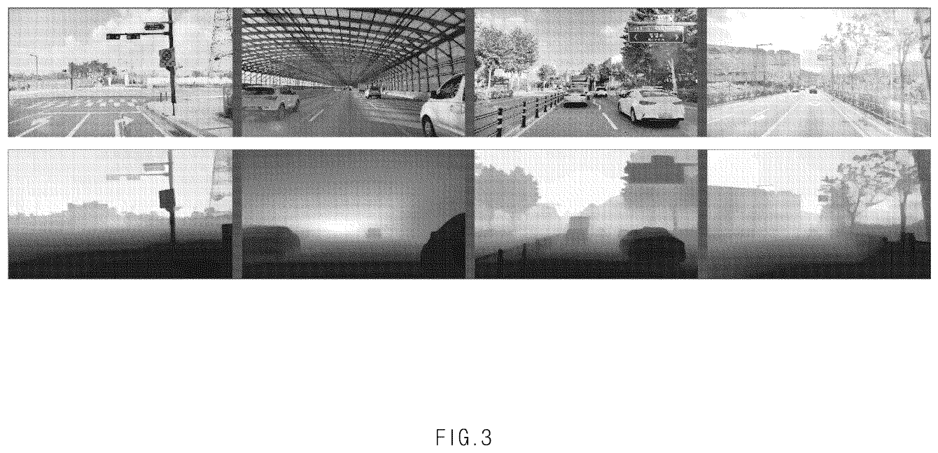

However, as may be identified in the pseudo depth map of FIG. 3 (i.e., images located in a second row of FIG. 3), the pseudo depth map generated from the pre-trained high-capacity network may include very similar information in terms of shape or structure with an original image.

Thus, such an advantage may be used to train the estimated depth map generation network 1200. In other words, the estimated depth map generation network 1200 may be trained using the second loss based on the pseudo depth map which is relatively smaller in accuracy than the GT depth map, but includes accurate information by the GT depth map in information about the shape or structure of the original image.

In other words, unsupervised learning (or self-supervised learning) may be performed using the first loss based on the image sequence and supervised learning may be simultaneously performed using the second loss based on the pseudo GT map (or the pseudo depth map) from the pseudo depth map generation network 1700 to considerably increase the performance of the estimated depth map generation network 1200.

For example, the loss calculation device 1500 may calculate the first loss based on the composite image and the target image.

For example, the loss calculation device 1500 may calculate the first loss with reference to at least some of luminance information, contrast information, and structure information of each of the composite image and the target image.

For reference, the equation of the first loss may be as follows.

$$pe ( {I}_{a} , {I}_{b} ) = \frac{α}{2} ( 1 - SSIM ( {I}_{a} , {I}_{b} ) ) + ( 1 - α ) {‖ {I}_{a} - {I}_{b} ‖}_{1} \qquad [ Equation 1 ]$$

At this time, pe(Iₐ, I_{b}) may be the first loss, Iₐ may be the target image, I_{b} may be the composite image, SSIM(Iₐ, I_{b}) may be the similarity between Iₐ and I_{b} (the similarity between at some of the luminance information, the contrast information, and the structure information), ∥Iₐ−I_{b}∥₁ may be the regression loss (loss L1) of the pixel value for each pixel between Iₐ and I_{b}, and a may be the weighted sum ratio adjustment parameter of the structural similarity index map (SSIM) and loss L1. For reference, the first loss of Equation 1 above is only an example for helping understanding, and the first loss according to an embodiment disclosed in the present disclosure is not limited to Equation 1 above. For example, the first loss may fail to include ∥Iₐ−I_{b}∥₁ and a.

For reference, the equation of the SSIM is as follows.

$$SSIM ( {I}_{a} , {I}_{b} ) = {[ 1 ( {I}_{a} , {I}_{b} ) ]}^{α} * {[ c ( {I}_{a} , {I}_{b} ) ]}^{β} * {[ s ( {I}_{a} , {I}_{b} ) ]}^{γ} \qquad [ Equation 2 ]$$

At this time, α, β, and γ may have predetermined values. For example, the values of α, β, and γ may be “1”.

The equation of each of l (luminance), c (contrast), and s (structural) is as follows.

$$l ( x , y ) = \frac{2 {μ}_{x} {μ}_{y} + {c}_{1}}{{μ}_{x}^{2} + {μ}_{y}^{2} + {c}_{1}} \qquad [ Equation 3 ]$$

$$c ( x , y ) = \frac{2 {σ}_{x} {σ}_{y} + {c}_{2}}{{σ}_{x}^{2} + {σ}_{y}^{2} + {c}_{2}}$$

$$s ( x , y ) = \frac{{σ}_{xy} + {c}_{3}}{{σ}_{x} {σ}_{y} + {c}_{3}}$$

At this time, c1, c2, and c3 may be the predetermined constants, μ may be the average value, and σ may be the standard deviation.

Furthermore, the loss calculation device 1500 may calculate the second loss based on the pseudo depth map corresponding to the target image and the estimated depth map.

For example, the loss calculation device 1500 may calculate the second loss with reference to at least some of the luminance information, the contrast information, and the structure information of each of the pseudo depth map and the estimated depth map.

For reference, the equation of the second loss may be as follows.

$$pe ( {I}_{a} , {I}_{b} ) = ( 1 - SSIM ( {I}_{a} , {I}_{b} ) ) \qquad [ Equation 4 ]$$

At this time, pe(Iₐ, I_{b}) may be the second loss, Iₐ may be the pseudo depth map, I_{b} may be the estimated depth map, and SSIM(Iₐ, I_{b}) may be the similarity between Iₐ and I_{b} (the similarity between the at least some of the luminance information, the contrast information, and the structure information). For reference, because the equation of the SSIM is described with reference to Equation 2 above, a duplicated description thereof will be omitted.

At this time, a first weight α corresponding to the luminance information may be smaller than a second weight β corresponding to the contrast information and a third weight γ corresponding to the structure information.

For example, the value of α may be “0” and the value of β and the value of γ may be “1”. However, this is an example for helping understanding, and the present disclosure is not limited to the example.

For example, the first weight α and the second weight β may be smaller than the third weight γ.

Furthermore, the parameter update device 1600 may back-propagate the first loss and the second loss and may update a parameter of the estimated depth map generation network 1200 and a parameter of the pose change information generation network 1300.

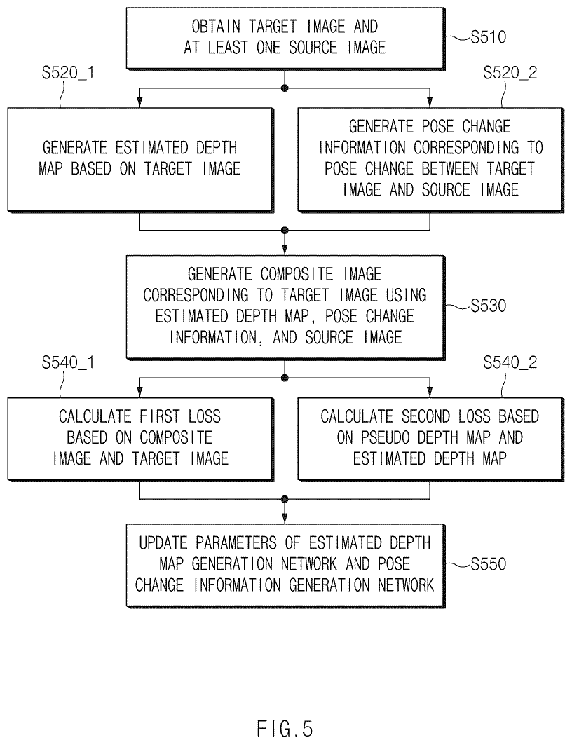

FIG. 5 is a flowchart illustrating an operation of a learning device.

Referring to FIG. 5, in operation 510, a learning device 1000 may obtain a target image and at least one source image.

In operation 520-1, the learning device 1000 may generate an estimated depth map based on the target image. In operation 520-2, the learning device 1000 may generate pose change information corresponding to a pose change between the target image and the source image.

In operation 530, the learning device 1000 may generate a composite image corresponding to the target image using the estimated depth map, the pose change information, and the source image.

In operation 540-1, the learning device 1000 may calculate a first loss based on the composite image and the target image. In operation 540-2, the learning device 1000 may calculate a second loss based on a pseudo depth map corresponding to the target image and the estimated depth map.

Furthermore, in operation 550, the learning device 1000 may back-propagate the first loss and the second loss and may update a parameter of an estimated depth map generation network 1200 and a parameter of a pose change information generation network 1300.

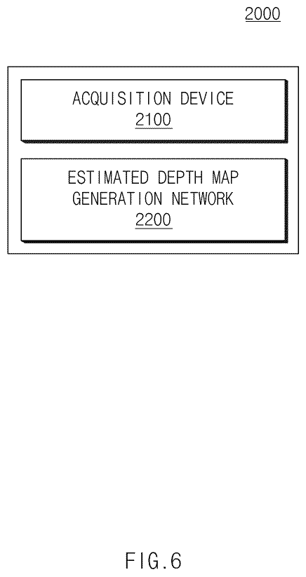

Meanwhile, a description will be given below of a test device 2000 including an estimated depth map generation network 2200, a parameter of which is updated using the learning device 1000 described above, with reference to FIGS. 6 to 8. For reference, a description duplicated with the same or similar description to the learning device 1000 will be omitted.

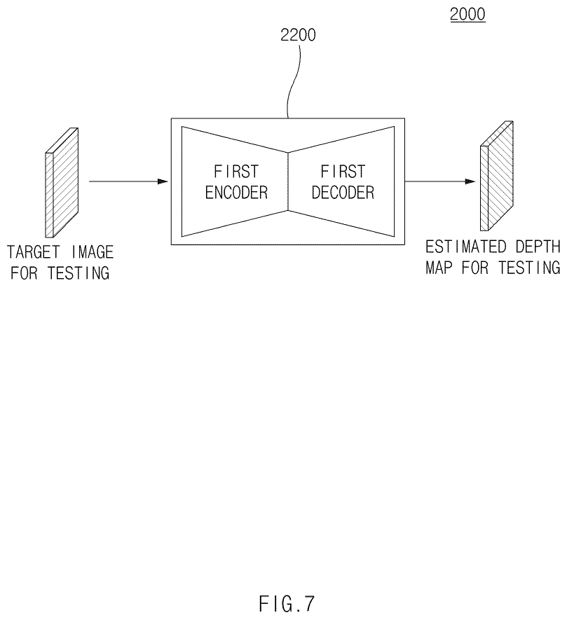

FIG. 6 is a block diagram illustrating a configuration of a test device 2000 according to an embodiment disclosed in the present disclosure. FIG. 7 is a drawing for describing an operation of a test device according to an embodiment disclosed in the present disclosure.

Referring to FIG. 6, the test device 2000 according to an embodiment disclosed in the present disclosure may include an acquisition device 2100 and an estimated depth map generation network 2200.

For reference, because a pose change information generation network 1300, a composite image generator 1400, a loss calculation device 1500, a parameter update device 1600, and a pseudo depth map generation network 1700 correspond to components required in a training operation to increase the accuracy of the estimated depth map generation network 2200, when compared with components of the learning device 1000 in FIG. 1, it may be identified that the test device 2000 does not include the pose change information generation network 1300, the composite image generator 1400, the loss calculation device 1500, the parameter update device 1600, and the pseudo depth map generation network 1700.

Hereinafter, a description will be given in detail of an operation of the test device 2000 according to an embodiment disclosed in the present disclosure with reference to FIG. 7.

First of all, the acquisition device 2100 may obtain a target image for testing. As described above, because of the state in which the training of the estimated depth map generation network 2200 is completed, a source image additionally necessary to train the estimated depth map generation network 2200 may fail to be required for inference of the estimated depth map generation network 2200.

The estimated depth map generation network 2200 may generate an estimated depth map for testing based on the target image for testing.

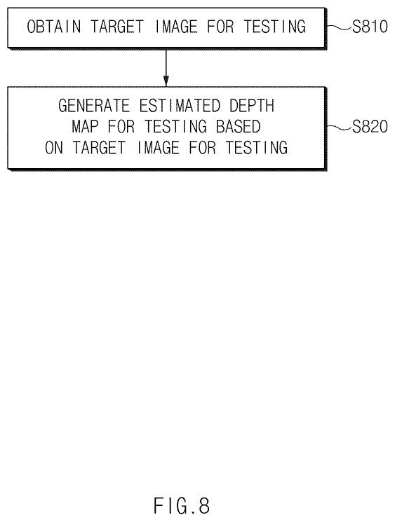

FIG. 8 is a drawing illustrating an operation of a test device.

Referring to FIG. 8, in operation 810, a test device 2000 may obtain a target image for testing.

In operation 820, the test device 2000 may generate an estimated depth map for testing based on the target image for testing.

Meanwhile, (i) the performance of the depth map estimation network trained using the first loss and the second loss according to an embodiment disclosed in the present disclosure is compared with (ii) the performance of the network trained using only the first loss. At this time, an image obtained by means of a front view camera and LiDAR data corresponding to the image are used for performance comparison between the two networks.

It may be identified that the accuracy of 72.34% is shown for the network trained using only the first loss, as a result of identifying performance by means of score al using the same data, whereas the accuracy of 87.93% is shown for the network trained using the first loss and the second loss. It may be identified that the accuracy of the estimated depth map generation network trained using the first loss and the second loss according to an embodiment disclosed in the present disclosure is much better.

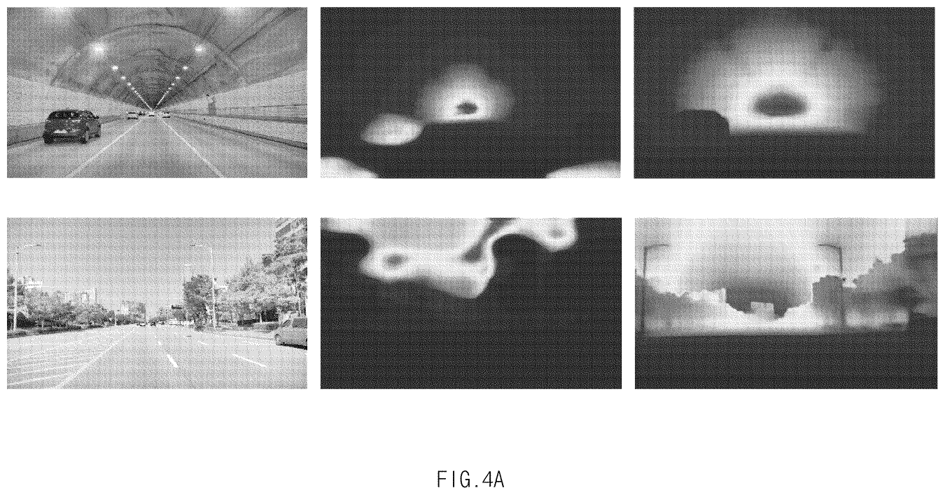

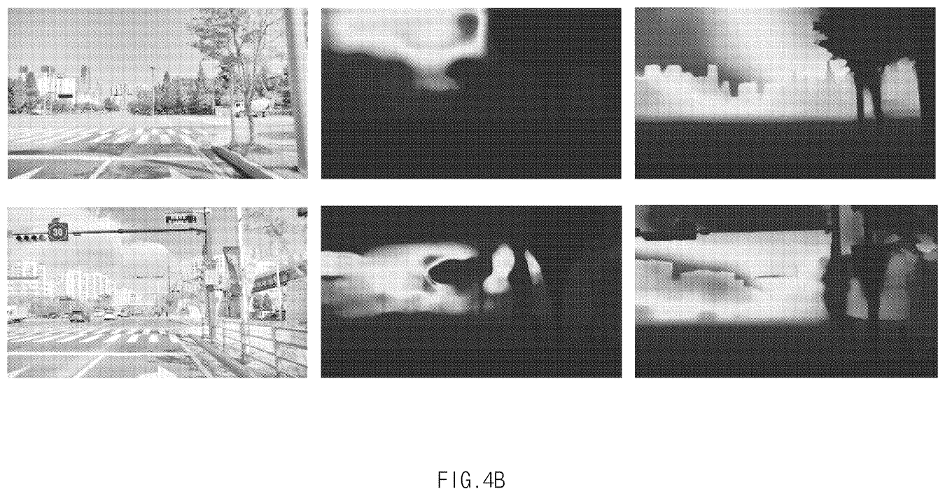

It may be identified with reference to FIGS. 4A and 4B. For reference, the left column is an input image, the middle column is an output depth map which is generated for the input image by the network trained using only the first loss, and the right column is an output depth map which is generated for the input image by the estimated depth map generation network trained using the first loss and the second loss according to an embodiment disclosed in the present disclosure.

Referring to FIGS. 4A and 4B, it may be identified that the depth map generated by the estimated depth map generation network trained using the first loss and the second loss according to an embodiment disclosed in the present disclosure is much greater in accuracy than the depth map generated by the network trained using only the first loss.

In detail, it may be identified that the estimated depth map generation network according to an embodiment disclosed in the present disclosure is much greater than the depth map generated by the network trained using only the first loss, in information about the shape and/or structure of the object as well as depth information.

Particularly, it may be identified that the shape of the object is not crushed on the estimated depth map even when the dynamic object is included in the image like FIG. 4A.

As a result, the estimated depth map generation network with high accuracy may be trained using only an image sequence obtained from a monocular camera.

Furthermore, the estimated depth map generation network may be trained by means of the second loss, thus generating an estimated depth map in which an object boundary is clearly represented for a dynamic object or an object, a portion of which is occluded.

The present technology may provide the learning device based on self-supervised learning, the learning method thereof, the test device using the same, and the test method using the same.

The present technology may provide the learning device for reducing time and cost consumed to ensure data for training for training a depth map generation network, the learning method thereof, the test device using the same, and the test method using the same.

The present technology may provide the learning device for allowing the depth map generation network to accurately estimate depth information based on an image sequence, the learning method thereof, the test device using the same, and the test method using the same.

The present technology may provide the learning device for accurately estimating depth information for a dynamic object or an occluded object in an image, the learning method thereof, the test device using the same, and the test method using the same.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A learning device comprising:
one or more processors; and
memory storing instructions that, when executed by the one or more processors, configure the learning device to:
obtain a target image and a source image;
generate, via a first network, an estimated depth map based on the target image;
generate, via a second network, pose change information corresponding to a pose change between the target image and the source image;
generate a composite image corresponding to the target image by using the estimated depth map, the pose change information, and the source image;
determine, based on the composite image and the target image, a first loss;
determine, based on a pseudo depth map corresponding to the target image and the estimated depth map, a second loss; and
back-propagate the first loss and the second loss, and update a parameter of the first network and a parameter of the second network.

2. The learning device of claim 1, wherein the instructions, when executed by the one or more processors, configure the learning device to determine the second loss by:
determining, via the loss calculation device, the second loss further based on at least one of luminance information, contrast information, or structure information, of each of the pseudo depth map and the estimated depth map.

3. The learning device of claim 2, wherein a first weight corresponding to the luminance information is smaller than a second weight corresponding to the contrast information and smaller than a third weight corresponding to the structure information.

4. The learning device of claim 1, wherein the target image is generated by an image sensor at a first time, and
wherein the source image is generated by the image sensor at a second time within a threshold range around the first time.

5. The learning device of claim 4, wherein the second network comprises a pose change information generation network, and
wherein the instructions, when executed by the one or more processors, configure the learning device to generate the pose change information by generating, via the second network, the pose change information based on a first pose at the first time and a second pose at the second time.

6. The learning device of claim 4, wherein the instructions, when executed by the one or more processors, configure the learning device to:
obtain, based on the estimated depth map, first three-dimensional (3D) point cloud information at the first time;
convert, based on the pose change information, the first 3D point cloud information at the first time into second 3D point cloud information at the second time;
convert, based on an image sensor parameter corresponding to the image sensor, the second 3D point cloud information into two-dimensional (2D) image coordinates; and
generate the composite image by generating the composite image based on a pixel value of the source image corresponding to the 2D image coordinates.

7. The learning device of claim 1, wherein the first network comprises an estimated depth map generation network, and
wherein the instructions, when executed by the one or more processors, further configure the learning device to:
generate, via a pseudo depth map generation network, the pseudo depth map based on the target image.

8. The learning device of claim 7, wherein the pseudo depth map generation network comprises a parameter in a frozen state.

9. A system comprising:
a test device comprising:
an acquisition device configured to obtain a target image for testing; and
a first network configured to generate, based on the target image, an estimated depth map for testing; and
a learning device configured to:
obtain the target image and a source image;
generate, via a second network, pose change information corresponding to a pose change between the target image and the source image;
generate a composite image corresponding to the target image by using the estimated depth map, the pose change information, and the source image;
determine, based on the composite image and the target image, a first loss;
determine, based on a pseudo depth map corresponding to the target image and the estimated depth map, a second loss; and
back-propagate the first loss and the second loss and update a parameter of the first network and a parameter of the second network,
wherein the test device is configured to perform testing based on the updated parameters.

10. The system of claim 9, wherein the test device is configured to determine the second loss by:
determining the second loss further based on at least one of luminance information, contrast information, or structure information, of each of the pseudo depth map and the estimated depth map.

11. The system of claim 10, wherein a first weight corresponding to the luminance information is smaller than a second weight corresponding to the contrast information and smaller than a third weight corresponding to the structure information.

12. The system of claim 9, wherein the target image is generated by an image sensor at a first time, and
wherein the source image is generated by the image sensor at a second time within a threshold range around the first time.

13. The system of claim 12, wherein the second network comprises a pose change information generation network, and wherein the test device is configured to generate the pose change information by generating, via the pose change information generation network, the pose change information based on a first pose at the first time and a second pose at the second time.

14. A learning method comprising:
obtaining, by one or more processors, a target image and a source image;
generating, by the one or more processors, an estimated depth map based on the target image;
generating, by the one or more processors, pose change information corresponding to a pose change between the target image and the source image;
generating, by the one or more processors, a composite image corresponding to the target image by using the estimated depth map, the pose change information, and the source image;
determining, by the one or more processors and based on the composite image and the target image, a first loss;
determining, by the one or more processors and based on a pseudo depth map corresponding to the target image and the estimated depth map, a second loss; and
back-propagating, by the one or more processors, the first loss and the second loss and updating a parameter of a first network for generating the estimated depth map and a parameter of a second network for generating the pose change information.

15. The learning method of claim 14, wherein the determining of the second loss comprises:
determining the second loss further based on at least one of luminance information, contrast information, or structure information, of each of the pseudo depth map and the estimated depth map.

16. The learning method of claim 15, wherein a first weight corresponding to the luminance information is smaller than a second weight corresponding to the contrast information and smaller than a third weight corresponding to the structure information.

17. The learning method of claim 14, wherein the target image is generated by an image sensor at a first time, and
wherein the source image is generated by the image sensor at a second time within a threshold range around the first time.

18. The learning method of claim 17, wherein the generating of the pose change information comprises:
generating the pose change information based on a first pose at the first time and a second pose at the second time.

19. The learning method of claim 17, wherein the generating of the composite image comprises:
obtaining first three-dimensional (3D) point cloud information at the first time;
converting, based on the pose change information, the first 3D point cloud information at the first time into second 3D point cloud information at the second time;
converting, based on an image sensor parameter corresponding to the image sensor, the second 3D point cloud information into two-dimensional (2D) image coordinates; and
generating the composite image based on a pixel value of the source image corresponding to the 2D image coordinates.

20. The learning method of claim 14, further comprising:
generating, by a pre-trained pseudo depth map generation network, the pseudo depth map based on the target image before determining the second loss.
